(19) United States
(12) Patent Application Publication
(10) Pub. No.: US 2023/0118059 A1
(43) Pub. Date: Apr. 20, 2023

(54) REMOVABLE AND REPLACEABLE BATTERY PACK

(71) Applicant: Briggs & Stratton, LLC, Wauwatosa, WI (US)

(72) Inventors: Michael Gigot, Wauwatosa, WI (US); Jacob Schmalz, Milwaukee, WI (US); Michael David Marshall, Jackson, WI (US)

(21) Appl. No.: 17/966,129

(22) Filed: Oct. 14, 2022

Related U.S. Application Data
(60) Provisional application No. 63/256,243, filed on Oct. 15, 2021.

(51) Int. Cl. H01M 50/256; H01M 50/224; H01M 50/249; H01M 50/505; H01M 10/42; H01M 10/48

(52) U.S. Cl. CPC H01M 50/256; H01M 50/224; H01M 50/249; H01M 50/505; H01M 10/425; H01M 10/488; H01M 2010/4271; H01M 2220/20

(57) ABSTRACT

A removable and replaceable battery pack includes a plurality of battery cells, an outer housing configured to encase the plurality of battery cells, a handle extending from the outer housing configured to be grasped by a user, an electrical connector located on a rear side of the outer housing, and a plurality of MOSFETs configured to control a current output to the electrical connector. The electrical connector includes a plurality of ports and is configured to electrically couple to a battery receptacle connector. Each of the plurality of MOSFETs is thermally coupled to the outer housing.

### CROSS-REFERENCE TO RELATED PATENT APPLICATIONS

This application claims the benefit of and priority to U.S. Provisional Application No. 63/256,243, filed on Oct. 15, 2021, the entire disclosure of which is hereby incorporated by reference herein.

### BACKGROUND

Current trends for outdoor power equipment, including lawn mowers, include adding electrification to replace or supplement the power that has traditionally been provided by an internal combustion engine.

### SUMMARY

At least one embodiment relates to a removable and replaceable battery pack that includes a plurality of battery cells, an outer housing configured to encase the plurality of battery cells, a handle extending from the outer housing configured to be grasped by a user, an electrical connector located on a rear side of the outer housing, and a plurality of MOSFETs configured to control a current output to the electrical connector. The electrical connector includes a plurality of ports and is configured to electrically couple to a battery receptacle connector. Each of the plurality of MOSFETs is thermally coupled to the outer housing

Another embodiment relates to a battery power system that includes one or more removable and replaceable battery packs and one or more battery pack receptacles. Each removable and replaceable battery pack includes a plurality of battery cells, an outer housing configured to encase the plurality of battery cells, a handle extending from the outer housing, a pack electrical connector located on a rear side of the outer housing and having a plurality of ports, and a plurality of MOSFETs configured to maintain a current output within a threshold by applying pulse width modulation. Each receptacle includes a receptacle electrical connector having a plurality of ports and being configured to electrically couple to the pack electrical connector of a respective one of the one or more removable and replaceable battery packs, and a latch configured to selectively couple to a respective one of the one or more removable and replaceable battery packs.

Another embodiment relates to a removable and replaceable battery pack that includes an outer housing fabricated from a die cast aluminum material, a plurality of battery cells enclosed within the outer housing, a handle extending from the outer housing, an electrical connector located on a rear side of the outer housing and electrically coupled to the plurality of battery cells, and a plurality of MOSFETs configured to control a current output to the electrical connector. Each of the plurality of MOSFETs is thermally coupled to the outer housing so that heat generated by the plurality of MOSFETs is conducted through the outer housing.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a removable battery pack, according to some embodiments;

FIG. 2 is a rear perspective view of the removable battery pack of FIG. 1, depicting an electrical connector port for electrically coupling the removable battery pack and a battery receptacle;

FIG. 3 is a front view of the removable battery pack of FIG. 1;

FIG. 4 is a top view of the removable battery pack of FIG. 1;

FIG. 5 is a side view of the removable battery pack of FIG. 1;

FIG. 6 is front perspective view of a cell module assembly housed within the removable battery pack of FIG. 1;

FIG. 7 is rear perspective view of the cell module assembly of FIG. 6;

FIG. 8 is a schematic illustration of a battery management system of the removable battery pack of FIG. 1;

FIG. 9 is a schematic illustration of transistors or switches enclosed within an outer housing of the removable battery pack of FIG. 1;

FIG. 10 is a perspective view of a latch or dock assembly for coupling to the removable battery pack of FIG. 1;

FIG. 11 is a top perspective view of the dock assembly of FIG. 7 mounted on a chore product or outdoor power equipment;

FIG. 12 is a top perspective view of the dock assembly mounted on the chore product or outdoor power equipment of FIG. 11 with the removable battery pack of FIG. 1 coupled to the dock assembly of FIG. 10; and

FIG. 13 is a schematic illustration of the connections between multiple removable battery packs of FIG. 1, a control unit, a charging circuit, and a motor, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically-powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

It is contemplated that battery pack described herein may be implemented on other electrified chore products or “light” electrified vehicles, machines, or equipment, including outdoor power equipment, indoor power equipment, light vehicles, floor care devices, golf carts, lift trucks and other industrial vehicles, pavement surface preparation devices, recreational utility vehicles, industrial utility vehicles, lawn and garden equipment, and/or still other suitable vehicles, machines, or equipment. Outdoor power equipment may include lawn mowers, riding tractors, snow throwers, pressure washers, tillers, log splitters, walk-behind mowers, riding mowers, and turf equipment such as sod cutters, aerators, spreaders, sprayers, seeders, power rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. Indoor power equipment may include floor sanders, floor buffers and polishers, vacuums, etc. Recreational utility vehicles may include all-terrain vehicles (“ATVs”), utility task vehicles (“UTVs”), etc. Industrial utility vehicles may include forklifts, aircraft tugs, aerial lifts such as scissor lifts and boom lifts, etc.

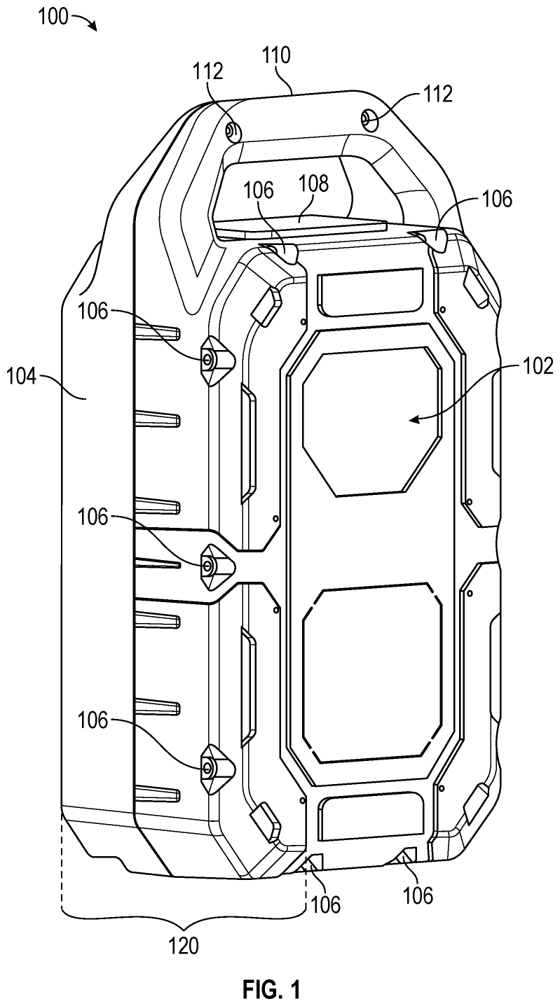

Referring now to FIG. 1, a removable battery pack 100 is shown, according to an exemplary embodiment. The removable battery pack 100 is removable and rechargeable (e.g., swappable). The removable battery pack 100 is configured to be inserted (e.g., dropped, lowered, placed) into a receptacle integrated with a piece of equipment, a chore product, and/or a charging station. In some embodiments, the removable battery pack 100 weighs less than thirty pounds. The removable battery pack 100 can be installed into a piece of equipment vertically, horizontally, or at any angle. The removable battery pack 100 may be a Lithium-ion battery. However, other battery types are contemplated, such as nickel-cadmium (NiCD), lead-acid, nickel-metal hydride (NiMH), lithium polymer, etc. In some embodiments, the removable battery pack 100 yields a voltage of approximately 48 Volts (V) and 1500 Watt-hours (Wh) of energy. In some embodiments, the removable battery pack 100 may have a peak discharge current of 200 amps. As will be described, the removable battery pack 100 includes one or more battery cells positioned therein. The removable battery pack 100 may also be hot-swappable meaning that a drained removable battery pack 100 can be exchanged for a new removable battery pack 100 without completely powering down connected equipment. As such, downtime between removable battery pack 100 exchanges is eliminated.

The removable battery pack 100 can be removed by an operator from a piece of equipment or a chore product without the use of tools and recharged using a charging station, as described further herein. In this way, the operator may use a second rechargeable battery having a sufficient charge to power equipment/products while allowing the first battery to recharge. Due to its uniformity across equipment, the removable battery pack 100 can also be used as part of a rental system, where rental companies who traditionally rent out pieces of equipment can also rent the removable battery pack 100 to be used on such equipment. An operator can rent a removable battery pack 100 to use on various types of equipment the operator may own and/or rent and then return the removable battery pack 100 to be used by other operators on an as-needed basis. In some embodiments, the removable battery pack 100 may be charged via an onboard charger on a piece of power equipment and/or vehicle. In alternative embodiments, the removable battery pack 100 may be charged via a charging station configured to charge the battery.

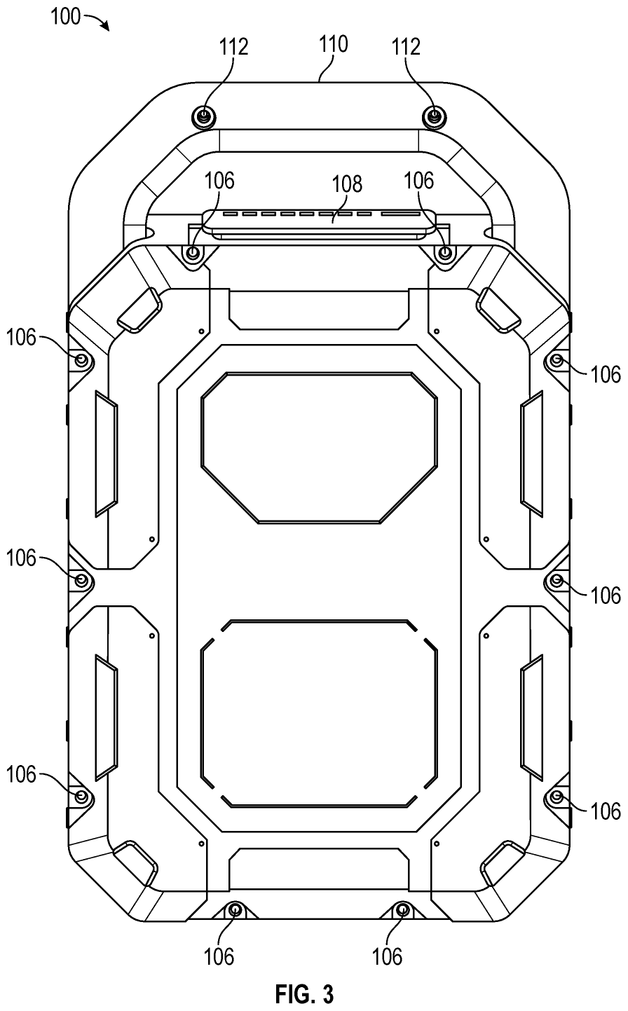

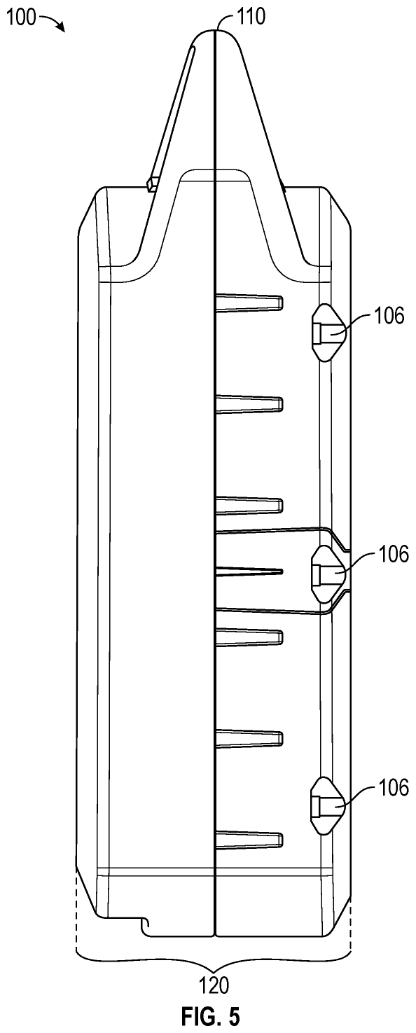

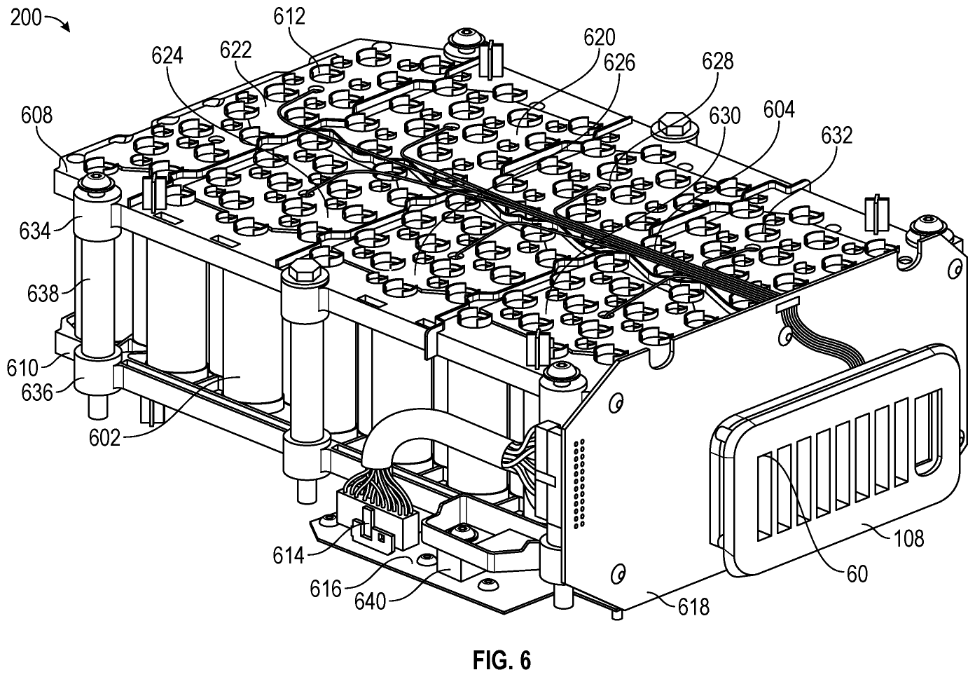

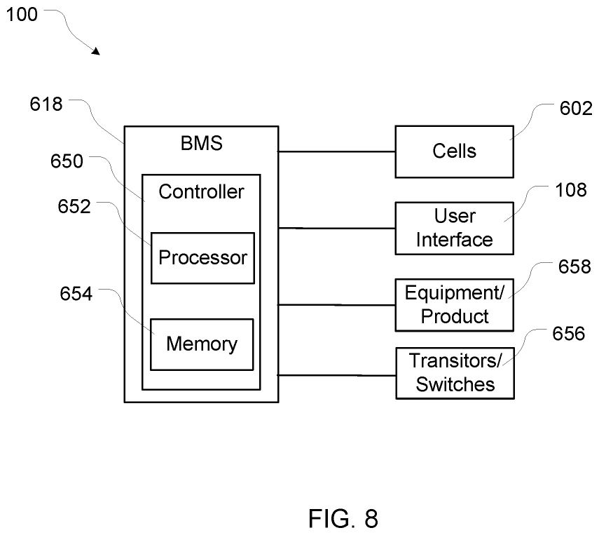

Still referring to FIGS. 1-5, the battery pack 100 includes a front portion 102 and a back or rear portion 104. In some embodiments, the front portion 102 and the rear portion 104 may be coupled together (e.g., welded, fused, etc.) to create an outer housing 120 of the removable battery pack 100. More specifically, the outer housing 120 houses one or more battery cells within the removable battery pack 100 (see, e.g., FIGS. 6-8). In some embodiments, the one or more battery cells may be coupled to the outer housing using fasteners 106 (e.g., bolts, screws, nails, etc.). In other embodiments, the one or more battery cells may be welded or otherwise fused to the outer housing. In some embodiments, the outer housing 120 may be fabricated from a die cast aluminum material. In general, the use of a die cast aluminum material provides structural integrity to the outer housing 120 and aids in heat removal from the interior cavity of the outer housing 120. For example, in some embodiments, the heat-generating components (e.g., transistors, metal-oxide-semiconductor field-effect transistors (MOSFETs), MOSFET switches, etc.) may be thermally coupled to or in engagement with the outer housing 120 to aid in heat transfer from the heat-generating components to the environment surrounding the outer housing 120.

In some embodiments, the removable battery pack 100 may include a user interface 108 configured to display an remaining energy to a user. For example, the user interface may use LED lights that light up based on the energy remaining of the removable battery pack 100. Additionally, the LED lights may blink or flash battery fault codes. The user interface 108 can provide additional information about the battery assembly 100 including condition, tool specific data, usage data, faults, etc. For example, battery indications may include, but are not limited to, charge status, faults, battery health, battery life, battery mode, unique battery identifier, link systems, etc.

As mentioned above, the removable battery pack 100 is configured to be removable and graspable. In some embodiments, the removable battery pack 100 includes a handle 110 that is coupled to the outer housing 120. In some embodiments, the handle 110 extends from a top side of the outer housing 120. In some embodiments, the handle 110 is formed integrally with the front portion 102 and the rear portion 104, with each including half of the handle 110. When the front portion 102 and the rear portion 104 are coupled together by fasteners 112, the halves of the handle 110 may come together to complete the handle 110. In some embodiments, the user interface 108 is positioned under the handle 110.

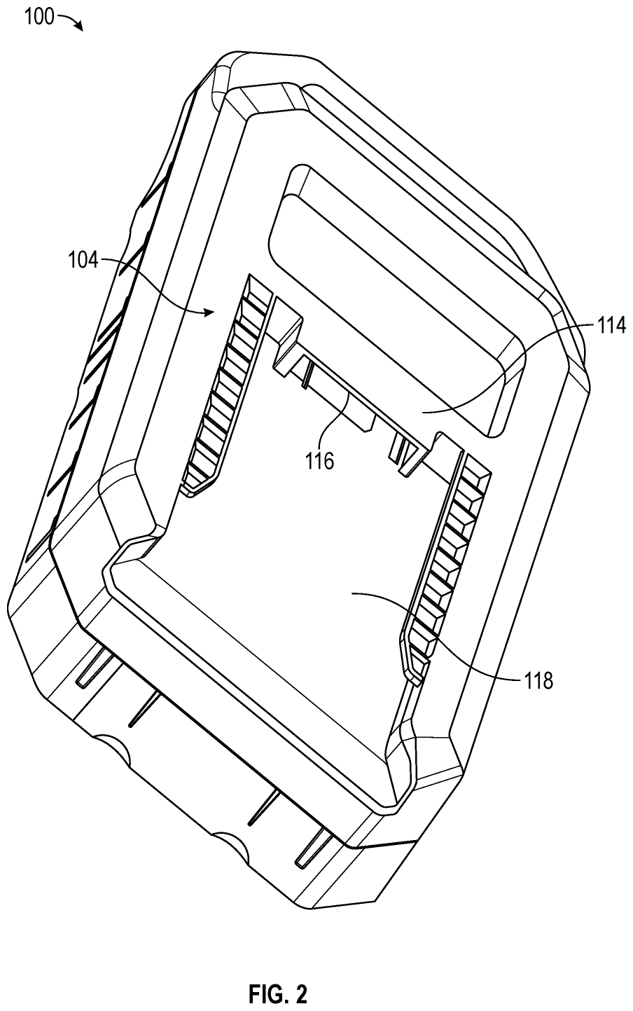

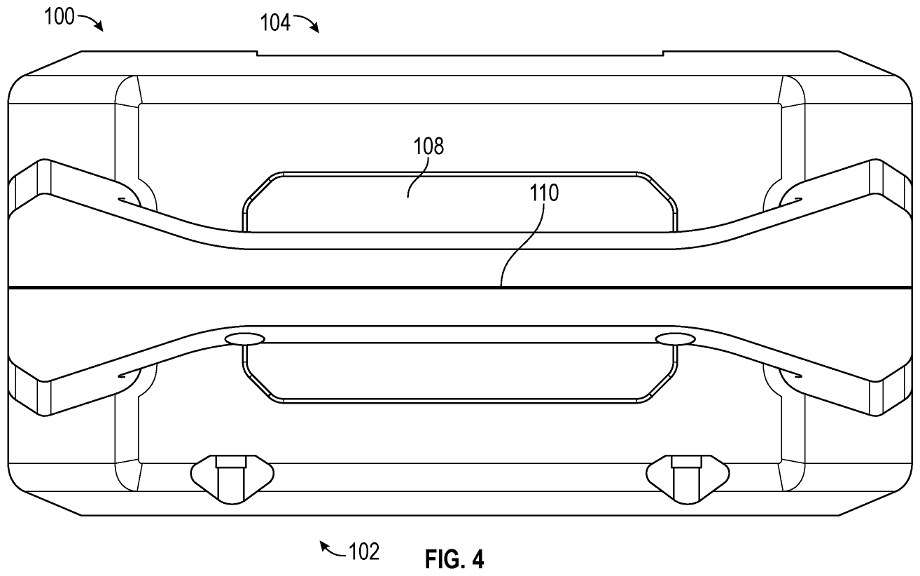

Referring specifically to FIG. 2, a rear perspective view of the removable battery pack of FIG. 1 is shown. In some embodiments, the rear portion 104 of the removable battery pack 100 includes a mating feature 114 positioned proximate the center of the rear portion 104. In some embodiments, the mating feature 114 may be configured to be coupled to a latching or dock assembly as described in more detail herein. The mating feature 114 may include a mating feature opening 116 and one or more ports/electrical connectors positioned therein (e.g., the pack electrical connector 702 is configured to be accessible through the mating feature opening 116). The electrical connector 702 arranged within the mating feature 114 is configured to supply power from one or more battery cells housed in the outer housing 120 through the ports/electrical connectors thereof and selectively connect the removable battery pack 100 with a latch or dock assembly of at least one of a piece of power equipment, a chore product, or a charging station. In general, the mating feature opening 116 and the corresponding electrical connector 702 being arranged on the rear portion 104 of the outer housing 120 provides efficient access to the electrical connector 702. In some embodiments the rear portion or side 104 of the outer housing 120 defines a greater width (e.g., measured in a left-to-right direction from the perspective of FIG. 4) than lateral sides (e.g., left and right sides from the perspective of FIG. 4) of the outer housing 120 (e.g., measured in an up-and-down direction from the perspective of FIG. 4). In some embodiments, the mating feature 114 may further include a lock (e.g., latch, clip) configured to couple and decouple (e.g., lock and unlock) the removable battery pack 100 to a respective feature on a dock assembly, a charging station and/or a piece of equipment.

Turning to FIGS. 6-8, a cell module assembly (CMA) 200 housed within the outer housing 120 of the removable battery pack 100 is shown, according to an exemplary embodiment. Generally, the cell module assembly 200 may include multiple battery cells 602 that can together output power to operate a piece of power equipment (e.g., through the electrical connector 702). In some embodiments, the battery cells 602 may be lithium-ion battery cells. In some embodiments, the cell module assembly 200 include ninety-eight battery cells 602. In some embodiments, the ninety-eight battery cells 602 are grouped in groups of seven and connected in a parallel configuration. The groups of seven may then be connected in a series configuration to achieve a desired voltage. In some embodiments, the battery cells 602 may be electrically connected to one another using conducting wires and common conductors (e.g., front collector plates 620, 622, 624, 626, 628, 630, and 632). Similarly, on the back side, the battery cells 602 may be electrically connected to one another using conducting wires and common conductors (e.g., back collector plates 708, 710, 712, 714, 716, and 718)

The battery cells 602 may be supported by a front frame 608 and a back frame 610. The front frame 608 and the back frame 610 can each be continuous components (e.g., unitary) formed of insulating polymeric materials. The front frame 608 and the back frame 610 may be generally rectangular in shape. Each of the front frame 608 and the back frame 610 may include a plurality of cylindrical protrusions 612 extending outwardly and away from the respective frames 608, 610. The cylindrical protrusions 612 each define a pockets that can each receive a battery cell 602. In some embodiments, the front frame 608 and back frame 610 may include one or more collars positioned about their outer perimeter. For example, collars 634 and 636 may be positioned about the outer perimeter of the front frame 608 and the back frame 610, respectively. Generally, the collars 634, 636 may include a cylindrical inner wall configured to receive compression limiters. For example, collars 634 and 636 may be configured to receive compression limiter 638. The compression limiters 638 may have a generally tubular shape.

In some embodiments, the compression limiters 638 may be defined by a height (i.e., a longitudinal length) that is larger than a height of each battery cell 602. By being taller than the battery cells 602, compressive loading experienced by either of the front frame 608 and the back frame 610 is initially diverted to the compression limiters 638, which engages the collars 634 and 636). The compression limiters 638 keep the front frame 608 and the back frame 610 at a fixed distance apart from one another, which prevents the frames 608, 610 from applying extreme or otherwise unwanted compressive stress to each battery cell 602 that could be caused by loading from another CMA positioned adjacent to the CMA 600, for example.

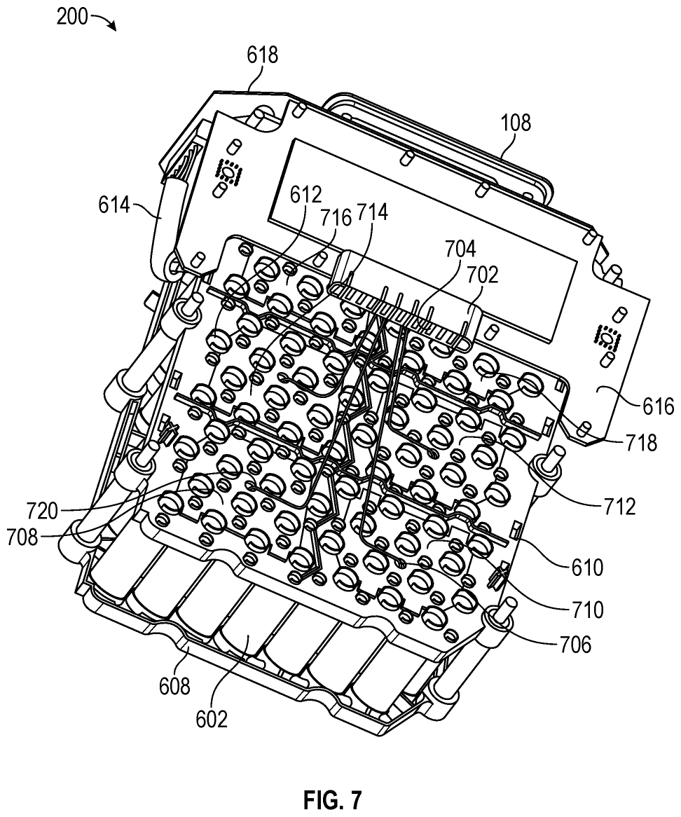

In some embodiments, the cell module assembly 200 also includes a pack electrical connector 702 including one or more ports 704 (see, e.g., FIG. 7). The pack electrical connector 702 may be configured to electrically couple the cell module assembly 200, through a power interface board 616, to a dock or latch assembly, a charging station, or piece of power equipment/chore product. In some embodiments, the pack electrical connector 702 may be positioned adjacent to or within mating feature 114 within the outer housing 120 so that the ports 704 are accessible through the mating feature opening 116.

In some embodiments, the cell module assembly 200 includes one or more wires 706 configured to provide an electrical output (e.g., current, voltage, power, etc.) to the pack electrical connector 702. More specifically, the cell module assembly 200 may include one wire connecting each common conductor (e.g., back collector plates 708, 710, 712, 714, 716, and 718) to the electrical connector. For example, wire 706 may be connected to collector plate 710 and wire 720 may be connected to collector plate 708, as illustrated in FIG. 7.

In some embodiments, the cell module assembly 200 may also include an electrical cord (e.g., wire harness) 614 configured to connect the power interface board 616 to a BMS 618. The electrical cord 614 may be configured to facilitate communication between the BMS 618 and the power interface board 616 through multiple signal lines. The BMS 618 includes a controller 650 having a processing circuit with a processor 652 and memory 654. The processing circuit can be communicably connected to a communications interface such that the processing circuit and the various components thereof can send and receive data via the communications interface. The processor 652 can be implemented as a general purpose processor, an application specific integrated circuit (“ASIC”), one or more field programmable gate arrays (“FPGAs”), a group of processing components, or other suitable electronic processing components.

The memory 654 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 654 can be or include volatile memory or non-volatile memory. The memory 654 can include database components, object code components, script components, or any other type of information structure for supporting the various activities and information structures described in the present application. According to some embodiments, the memory 654 is communicably connected to the processor 652 via the processing circuit and includes computer code for executing (e.g., by the processing circuit and/or the processor 652) one or more processes described herein.

In some embodiments, the cell module assembly 200 may include an electrical connector 640 configured to connect the bus bars extending from the positive and negative terminals of the common conductors to the power interface board 616 so as to transfer power from the plurality of battery cells 602 to the power interface board 616. Power is then routed through a high power switch within the power interface board 616 before reaching the electrical connector 702. In some embodiments, the power interface board 616 may be a printed circuit board.

In some embodiments, the BMS 618 may be positioned at the top of the cell module assembly 200 (e.g., adjacent to a top side of the outer housing 120 near the user interface 108). In other embodiments, the BMS 618 may be included in any location within the cell module assembly 200. In some embodiments, the BMS 618 may be electrically coupled to one or more of the common conductors (e.g., front collector plates 620, 622, 624, 626, 628, 630, and 632 and/or back collector plates 708, 710, 712, 714, 716, and 718) through wires (e.g., wires 604, 706, and/or 720). The electrically connections between the BMS 618 and the top collector plates 620, 622, 624, 626, 628, 630, and 632 and the bottom collector plates 708, 710, 712, 714, 716, and 718 allows for a voltage reading across all of the battery cells 602. The BMS 618 is configured to manage the power output of the battery cells 152. The BMS 618 may be configured to allow the battery cells 602 to provide full power output to pack electrical connectors 702 to supply power to power equipment with which the removable battery pack 100 is connected. In some embodiments, the BMS 618 may allow battery cells 602 to be charged when removable battery pack 100 is connected to charging stations. The BMS 618 may also be configured to shut off power output from battery cells 602 to pack electrical connector 702, according to some embodiments.

In some embodiments, the BMS 618 may be a pulse width modulation (PWM) type controller configured to control one or more switches 656 (e.g., MOSFETS, transistors, etc.) to control and direct the current output of the battery cells 602 within the removable battery pack 100. For example, the BMS 618 may control six parallel MOSFETS within the power interface board 616 switching at a frequency of 20-30 kilo-hertz to control a current output from the battery cells 602 within the removable battery pack 100 (e.g., a current output to the electrical connector 702). In some embodiments, the PWM controller not only controls the current output from the power interface board 616, but also the current input into the removable battery pack 100 through the power interface board 616. In other words, the PWM-type controller controls a bi-directional current in and out of the removable battery pack 100 (e.g., through the electrical connector 702). A bi-directional current may enable the PWM type controller to diagnose potential errors within the removable battery pack 100. For example, if a fuse or wire was to become corrupted (e.g., corroded, blown, etc.) and the removable battery pack 100 was no longer able to produce a current, the PWM-type controller would allow current to flow into the removable battery pack 100 from an external source (e.g., a piece of power equipment, another removable battery pack, a charging station). The PWM-type controller may then be able to use the current flowing into the CMA 200 to diagnose the error within the battery pack 100.

In some embodiments, the BMS 618 may be configured to receive information from a piece of power equipment or chore product 658 that may be used to protect the removable battery pack 100 from harming itself or the equipment/product. For example, a piece of power equipment or chore product 658 may only have the capacity to receive 2 kilo-watts of power from a power source. In this case, this equipment/product power limit would be received by the BMS 618 and the BMS 618 may ensure that the power output of the removable battery pack 100 does not exceed this power limit. In some embodiments, the BMS 618 may receive this information via digital inputs, serial data (e.g., CAN), and/or wirelessly (e.g., Bluetooth, Wi-Fi, etc.).

In some embodiments, the BMS 618 may also be configured to record and store data regarding usage, cycles, power level, rental duration, etc., of the removable battery pack 100. The BMS 618 may also be configured to wirelessly connect to a remote database, a remote network, or a remote device, according to some embodiments. In some embodiments, BMS 618 may further be configured to control user interface 108. As noted above, the user interface 108 may display information to the operator, such as battery level, error messages, etc.

The user interface 108 may then use LED lights 606 (see, e.g., FIG. 6) to display a variety of battery information including but not limited to a state of charge, an energy remaining, and an operating range. In some embodiments, the user interface 108 may include 9 LED lights 606 that may be turned on or off depending on the energy remaining. For example, if the energy remaining is 30%, then three LED lights 606 may be turned on to show a 30% charge. The outer housing 120 may include an opening near the top of the removable battery pack 100 below the handle 110 that the user interface 108 may pass through so that it is visible on an exterior of the outer housing 120.

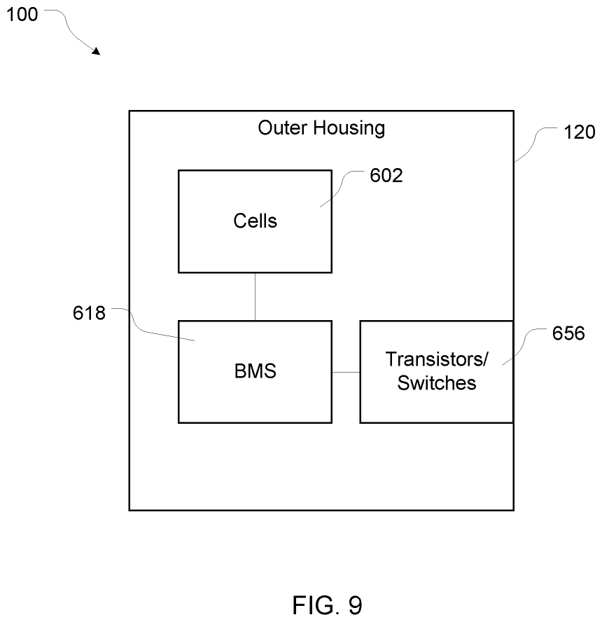

Turning to FIG. 9, as described herein, the outer housing 120 being formed from a die cast aluminum material provides improved heat transfer and heat removal when comparted to conventional battery packs (e.g., fabricated from plastic or another material with poor thermal conductivity). As shown in FIG. 9, in some embodiments the switches or transistors 656 (e.g., MOSFET switches) are coupled to the outer housing 120 to enable heat generated by the transistors or switches 656 to be removed by the outer housing 120. In some embodiments, the switches or transistors 656 are directly coupled (e.g., physically connected with no intervening components) to an internal surface of the outer housing 120 to provide a thermal coupling between the switches or transistors 656 and the outer housing 120. In some embodiments, the switches or transistors 656 are coupled to an internal surface of the outer housing 120 through an intermediate component (e.g., a thermally-conductive metal plate or bar (e.g., aluminum, copper, etc.)). In any case, the switches or transistors 656 are coupled to the outer housing 120 so that heat generated by the switches or transistors 656 is conducted through the outer housing 120, which aids in expelling heat to the surroundings of the removable battery pack 100.

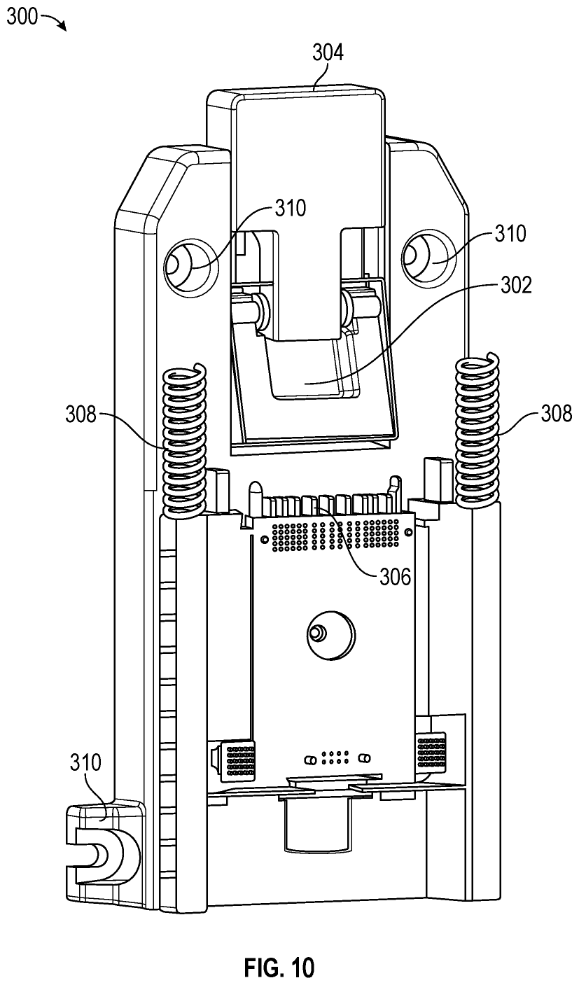

Referring now to FIG. 10, a latch or dock assembly 300 for coupling the removable battery pack 100 to a receptacle (e.g., a piece of power equipment, chore product, charging station, etc.) is shown, according to an exemplary embodiment. The latch assembly 300 may include lever 302 that when flattened or pivoted as a result of depressing button 304 may cause the outer housing 120 of the removable battery pack 100 to more readily slide down the lever 302 to couple with the latch assembly 300. More specifically, a receptacle electrical connector 306 with the pack electrical connector 702 to initiate power transfer between the removable battery pack 100 and a chore product or power equipment. In some embodiments, the latch assembly 300 may optionally include springs 308 that may further assist with coupling the receptacle electrical connector 306 with pack electrical connector 702. For example, the springs 308 can provide a removing force (e.g., acting upwardly from the perspective of FIG. 9) that aids in displacing the removable battery pack 100 toward a disengaged position where the electrical connector 702 is disconnected from the receptacle electrical connector 306. The latch assembly 300 may be coupled to a chore product or power equipment by fasteners that extend through fastener holes 310.

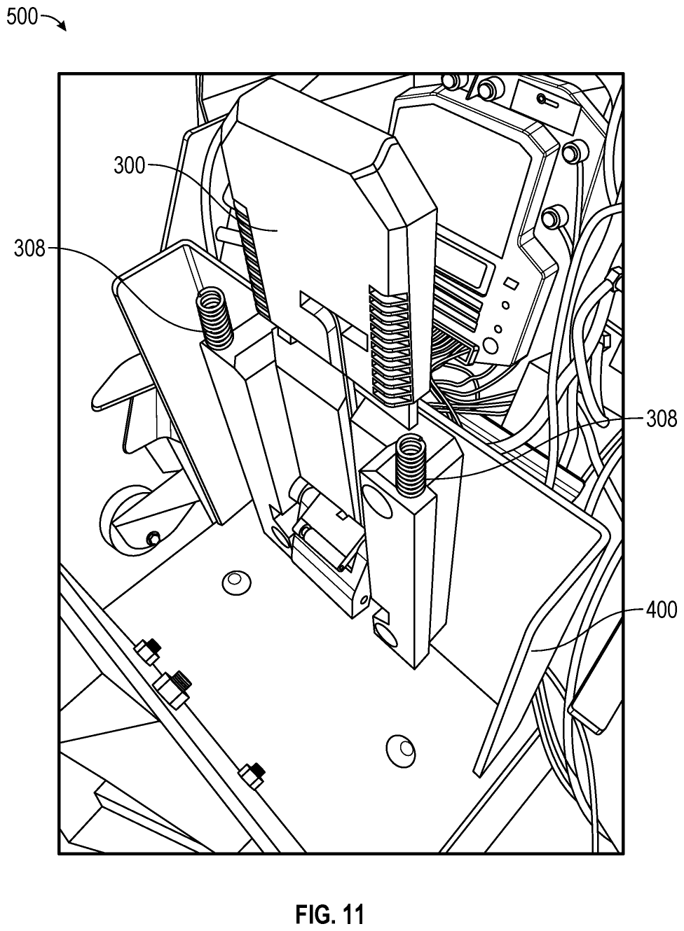

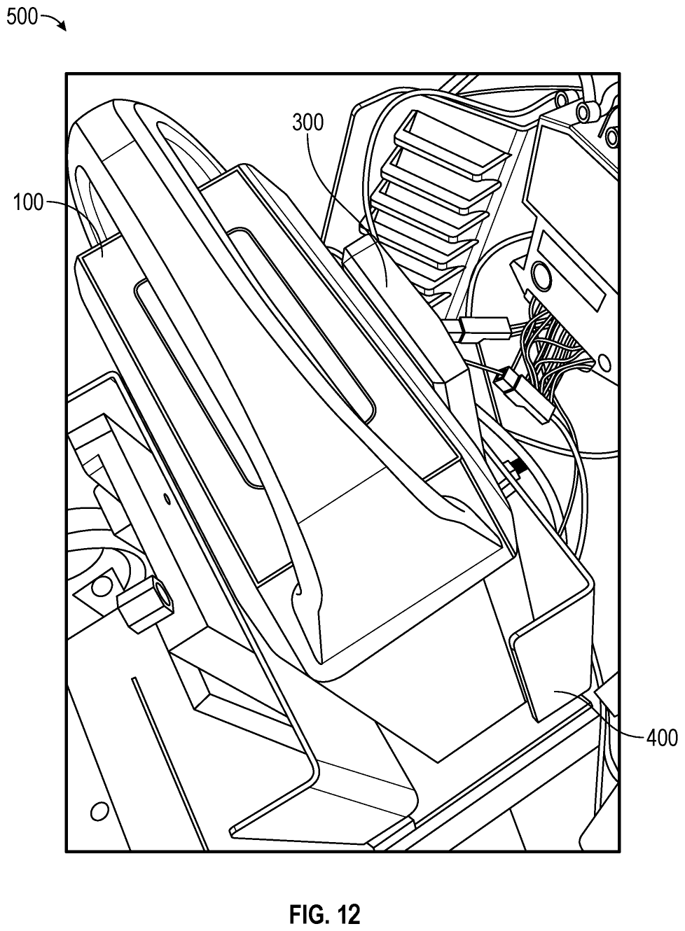

Referring now to FIGS. 11 and 12, a battery system 500 including a receptacle 400, the removable battery pack 100, and the latch assembly 300 is shown according to an exemplary embodiment. The latch assembly 300 is mounted to the receptacle 400 (e.g., a bracket) and the removable battery pack 100 is configured to be selectively installed on the latch assembly 300 to provide power transfer between the battery pack 100 and a chore product or power equipment that the receptacle 400 is installed on.

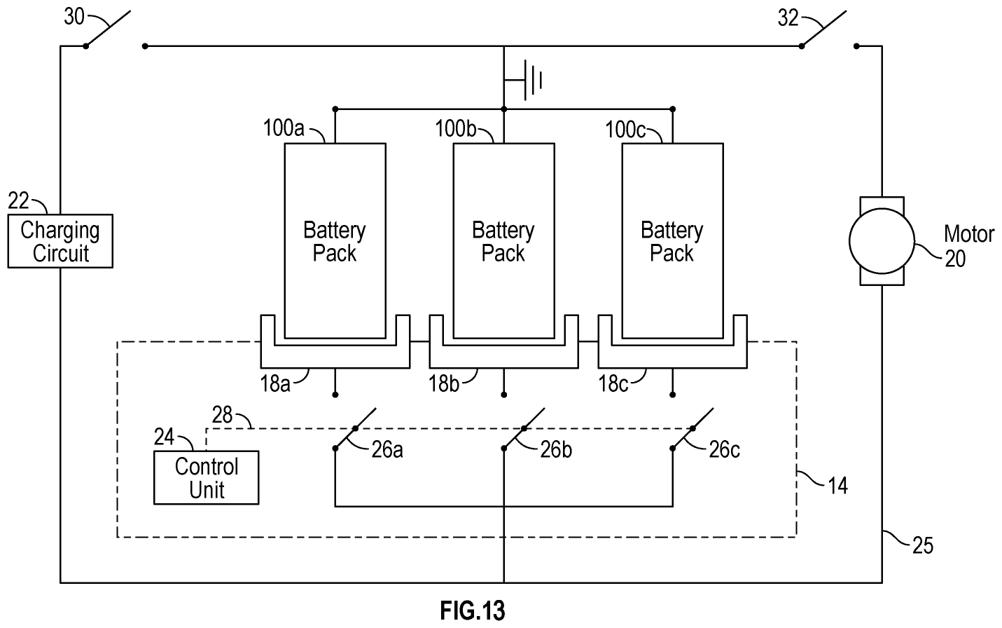

Referring now to FIG. 13, a schematic diagram for controlling the operation of one or more removable battery packs 100 (e.g., battery packs 100a-100c) connected in a parallel configuration is shown, according to an exemplary embodiment. The removable battery packs 100a-100c may include all the components of the removable battery pack 100 described above. FIG. 13 illustrates the electrical connections utilized to power one or more motors 20 and for recharging the battery packs 100a-100c utilizing a charging circuit 22. In the embodiment shown in FIG. 13, a control unit 24, which may be one of many different types of microprocessors or microcontrollers, is used to control the state of switching elements 26a-26c. The state of each of the individual switching elements 26 is controlled by the control unit 24 through a control line 28. Although a single control line 28 is shown in FIG. 11, it should be understood that multiple control lines could be utilized or a single control line 28 could be utilized while operating within the scope of the present disclosure. In addition, the switching elements 26a-26c could be either a single element (MOSFET, IGBT, transistor, relay, etc.) or could be a combination of a plurality of switching devices.

In some embodiments, each of the switching elements 26 is a high current MOSFET that can transition between an open and closed position through a control commands from the control unit 24. Although a MOSFET is described in one embodiment as the switching element 26, it should be understood that different types of switching elements could be utilized while operating within the scope of the present disclosure. Although the switching element 26 is displayed to be external to the removable battery pack 12, in some embodiments, the switching element may be internal to the battery pack 12.

As illustrated in FIG. 13, the first switch 26a is connected to the electrical contacts contained within the battery slot 18a to provide a connection between the battery pack 100a and a common power bus 25. In some embodiments, ground is connected to the battery at all times for proper operation of the battery pack. Switch 26b is positioned between the contacts in the battery slot 18b and ground to control the charging and discharging of the battery pack 100b. Finally, switch 26c is positioned in electrical connection with the battery slot 18c which receives the battery pack 100c. The control unit 24 is operable to selectively open and close each of the individual switches 26 as desired to control both the charging and discharging of the battery packs 12. Since the switches 26 are contemplated as being MOSFETS, the control unit 24 can open and close the switches 26 at rapid rates to selectively control the rate of charge from the charging circuit 22 or discharge to the motor 20.

A charging switch 30 is moved to the closed position during charging while the discharge switch 32 would be moved to the open position. Likewise, during discharge of the battery packs, the discharge switch 32 is moved to the closed position and the charging switch 30 is moved to the open position. The control unit 24 can also control the position of the switches 30, 32 to ensure that both of the switches 30, 32 are not in the closed position at the same time to prevent the charging circuit 22 from directly operating the electric motor 20.

Although the control unit 24 is shown as being contained within a battery tray 14, it should be understood that the control unit 24 could be located at other positions or locations, including inside one of the battery packs 12. However, positioning the control unit 24 within the battery tray 14 will allow the same control unit 24 to control the switches 26 during both charging and discharging of the battery packs 12.

In addition to controlling the position of the switches 26, the control unit 24 may also be configured to monitor the state of charge or energy remaining on each of the battery packs 12. An exemplary method of monitoring the state of charge on each of the battery packs 12 is to monitor the voltage of the respective battery packs utilizing a voltage sensor. In an illustrative example, the maximum state of charge of the battery packs will be 82 volts. When the output of the battery pack 12 falls to 80 volts, the battery pack will be at 80% charge. However, the determination of state of charge based on battery pack voltage is dependent on battery types, battery configurations, and other parameters. Accordingly, state of charge may be determined based on the battery pack voltage, and other relevant factors associated with the battery pack. Percent of maximum change will be used in the following exemplary discussion to illustrate the charging and discharging control by the control unit 24. By monitoring the state of charge on each of the individual battery packs 12, the control unit 24 would be able to selectively control the discharge rate of each of the individual battery packs 100a-100c as well as control the rate of charge of the individual battery packs 100a-100c. In this manner, it is contemplated that the control unit 24 would be able to maintain each of the battery packs 100a-100c at the same state of charge during both the discharge and charging cycles. In other embodiments, other methods of monitoring the battery packs remaining energy and/or state of charge may be used.

In the embodiment shown in FIG. 13, each of the switches 26a-26c is a MOSFET that is positioned within the battery tray 14. However, it is contemplated that the MOSFET switch 26 could be moved into the individual battery pack 12 (e.g., similar to the transistors/switches 656 within the removable battery pack 100) and be in communication with the control unit 24 through the individual battery slots 18. If the MOSFET switching element 26 were located within the battery pack 12 instead of within the battery tray 14, the MOSFET switch 26 would always move with the battery pack 12 rather than remaining within the battery tray 14. In another embodiment, both the battery pack 12 and the battery tray 14 could include switching elements. In yet another embodiment, the battery tray 14 may include a controllable fuse (e.g., a switching device such as a MOSFET, transistor, etc.) configured to prevent a live terminal in an empty battery slot. For example, if battery slot 18a is empty, the controllable fuse would disconnect the battery slot 18a from the common power bus.

Although the embodiments shown in FIG. 13 illustrate three battery packs connected in parallel, it is contemplated that additional battery packs could be utilized while operating within the scope of the present disclosure. For example, if a larger piece of power equipment (e.g., a riding lawn mower) was to be powered by the removable battery packs, one or more additional removable battery packs could be connected in the parallel arrangement to increase the output power of the combined unit. Adding an additional battery pack in parallel with the three battery packs shown in FIG. 13 will both increase the run-time and will slightly increase the voltage created by the parallel connected battery packs. The addition of battery packs in parallel will also increase the available power (increased current availability), which will increase runtime. The additional battery packs connected in parallel will also allow the output voltage to remain at the desired level for a longer period of time. Before allowing any additional removable packs to join the common bus, the control unit 24 might analyze one or more battery characteristics (e.g., open circuit voltage, energy remaining, etc.) to determine whether the removable battery pack would be able to safely join the common bus.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the removable battery pack 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A removable and replaceable battery pack, comprising:
a plurality of battery cells;
an outer housing configured to encase the plurality of battery cells;
a handle extending from the outer housing configured to be grasped by a user;
an electrical connector located on a rear side of the outer housing, the electrical connector includes a plurality of ports and is configured to electrically couple to a battery receptacle connector; and
a plurality of MOSFETs configured to control a current output to the electrical connector, wherein each of the plurality of MOSFETs is thermally coupled to the outer housing.

2. The removable and replaceable battery pack of claim 1, further comprising a battery management system configured to control the plurality of MOSFETs to maintain a current output within a threshold by applying pulse width modulation to the current output.

3. The removable and replaceable battery pack of claim 1, wherein the removable and replaceable battery pack weighs less than thirty pounds.

4. The removable and replaceable battery pack of claim 1, wherein the removable and replaceable battery pack is configured to supply at least 1.5 kilowatt-hours of energy.

5. The removable and replaceable battery pack of claim 1, further comprising a user interface configured to display a battery information, wherein the user interface is positioned at a top side of the outer housing under a handle.

6. The removable and replaceable battery pack of claim 1, wherein the outer housing is fabricated from a die cast aluminum material.

7. A battery power system, comprising:
one or more removable and replaceable battery packs, each removable and replaceable battery pack comprising:
a plurality of battery cells;
an outer housing configured to encase the plurality of battery cells;
a handle extending from the outer housing;
a pack electrical connector located on a rear side of the outer housing, the electrical connector comprising a plurality of ports; and
a plurality of MOSFETs configured to maintain a current output within a threshold by applying pulse width modulation; and
one or more battery pack receptacles, each receptacle comprising:
a receptacle electrical connector comprising a plurality of ports and configured to electrically couple to the pack electrical connector of a respective one of the one or more removable and replaceable battery packs; and
a latch configured to selectively couple to a respective one of the one or more removable and replaceable battery packs.

8. The battery power system of claim 7, further comprising a battery management system configured to send a bi-directional current into and out of one of the one or more removable and replaceable battery packs to diagnose an error.

9. The battery power system of claim 7, wherein the each of the one or more removable and replaceable battery packs is configured to be electrically coupled to a common power bus.

10. The battery power system of claim 7, wherein the one or more removable and replaceable battery packs are each configured to supply at least 1.5 kilowatt-hours.

11. The battery power system of claim 7, wherein each of the one or more removable and replaceable battery packs further comprises a user interface positioned under the handle and configured to display a battery information.

12. The battery power system of claim 7, wherein the outer housing of each of the one or more removable and replaceable battery pack is fabricated from a die cast aluminum material.

13. The battery power system of claim 12, wherein each of the plurality of MOSFETs of each of the one or more removable and replaceable battery packs is thermally coupled to the outer housing so that heat generated by the plurality of MOSFETs is conducted through the outer housing.

14. The battery power system of claim 7, wherein each of the one or more removable and replaceable battery packs weighs less than thirty pounds.

15. A removable and replaceable battery pack, comprising:
an outer housing fabricated from a die cast aluminum material;
a plurality of battery cells enclosed within the outer housing;
a handle extending from the outer housing;
an electrical connector located on a rear side of the outer housing, the electrical connector being electrically coupled to the plurality of battery cells; and
a plurality of MOSFETs configured to control a current output to the electrical connector, wherein each of the plurality of MOSFETs is thermally coupled to the outer housing so that heat generated by the plurality of MOSFETs is conducted through the outer housing.

16. The removable and replaceable battery pack of claim 15, further comprising a battery management system configured to control the plurality of MOSFETs to maintain a current output within a threshold by applying pulse width modulation to the current output.

17. The removable and replaceable battery pack of claim 15, wherein the removable and replaceable battery pack weighs less than thirty pounds.

18. The removable and replaceable battery pack of claim 15, wherein the removable and replaceable battery pack is configured to supply at least 1.5 kilowatt-hours of energy.

19. The removable and replaceable battery pack of claim 15, further comprising a user interface configured to display a battery information, wherein the user interface is positioned at a top side of the outer housing under a handle.

20. The removable and replaceable battery pack of claim 15, further comprising a battery management system configured to send a bi-directional current into and out of the electrical connector to diagnose an error.
